(19) United States
(12) Patent Application Publication
(10) Pub. No.: US 2003/0198260 A1
(43) Pub. Date: Oct. 23, 2003

(54) Method and apparatus for generating multiple wavelength radiation

(76) Inventors: Josh N. Hogan, Los Altos, CA (US); Anthony J. Ruggiero, Livermore, CA (US); Carol J. Wilson, San Jose, CA (US)

Correspondence Address: HUGH P. GORTLER, 23 ARRIVO DRIVE, MISSION VIEJO, CA, 92692, US

(21) Appl. No.: 10/124,889

(22) Filed: Apr. 18, 2002

(51) Int. Cl. H01S 3/10

(52) U.S. Cl. 372/21

(57) ABSTRACT

Laser radiation having a plurality of discrete wavelengths is generated by apparatus including a resonant cavity and a non-linear element within the cavity.

### BACKGROUND

Dense Wavelength Division Multiplexing (DWDM) achieves high data rate transmission by independently modulating data onto a multiplicity of optical beams having different wavelengths. These optical beams are then combined and propagated down a single optical fiber. DWDM is effective for high data rate optical communications because the different wavelengths, each modulated with different data, can be transmitted down the same optical fiber with substantially no cross-interference.

Multiple wavelength optical beams are typically generated by multiple laser diodes that emit at different wavelengths. Each laser diode is connected to an optical fiber. Each laser diode, fiber and optical connection increases system size and cost, and reduces system reliability and robustness. Thus multiple wavelength generation by a large number of laser diodes can have reliability, robustness, physical size and cost issues.

### SUMMARY

According to one aspect of the present invention, laser radiation having a plurality of discrete wavelengths is generated by an apparatus including a compound cavity and a non-linear element within the cavity. Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of a system for generating laser radiation at multiple discrete wavelengths.

FIG. 2 is an illustration of a spectral profile of a compound cavity for the system.

FIG. 3 is an illustration of a reflectivity profile of an input reflective element of the compound cavity.

FIG. 4 is an illustration of a reflectivity profile of an output reflective element of the compound cavity.

FIG. 5 is an illustration of an alternative reflectivity profile of the output reflective element.

FIG. 6 is an illustration of a first embodiment of the compound cavity.

FIG. 7 is an illustration of a second embodiment of the compound cavity.

FIG. 8 is an illustration of a third embodiment of the compound cavity.

FIG. 9 is an illustration of a fourth embodiment of the compound cavity.

FIG. 10 is an illustration of a fifth embodiment of the compound cavity.

### DETAILED DESCRIPTION

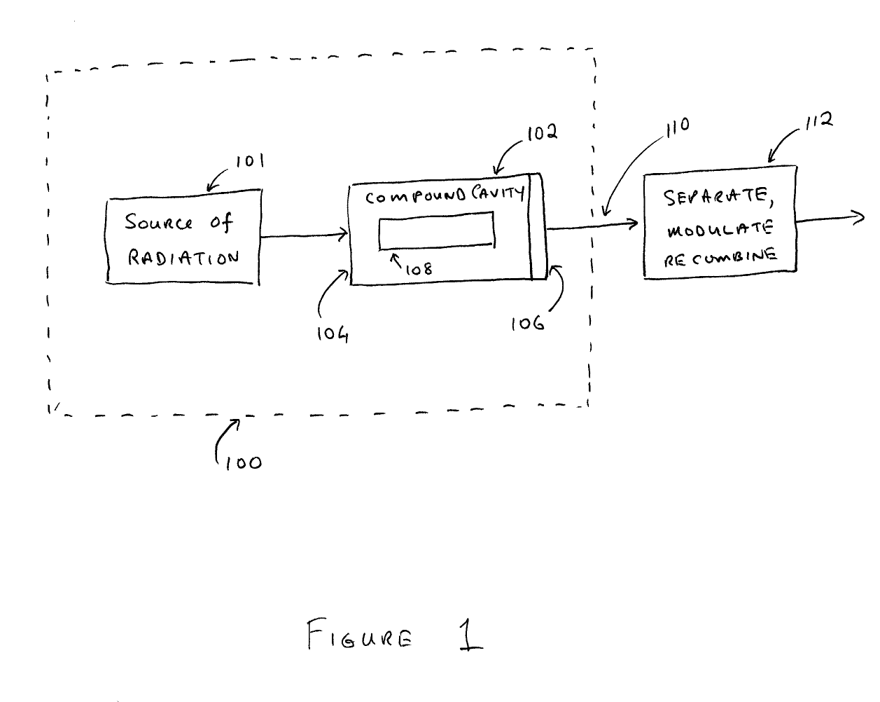

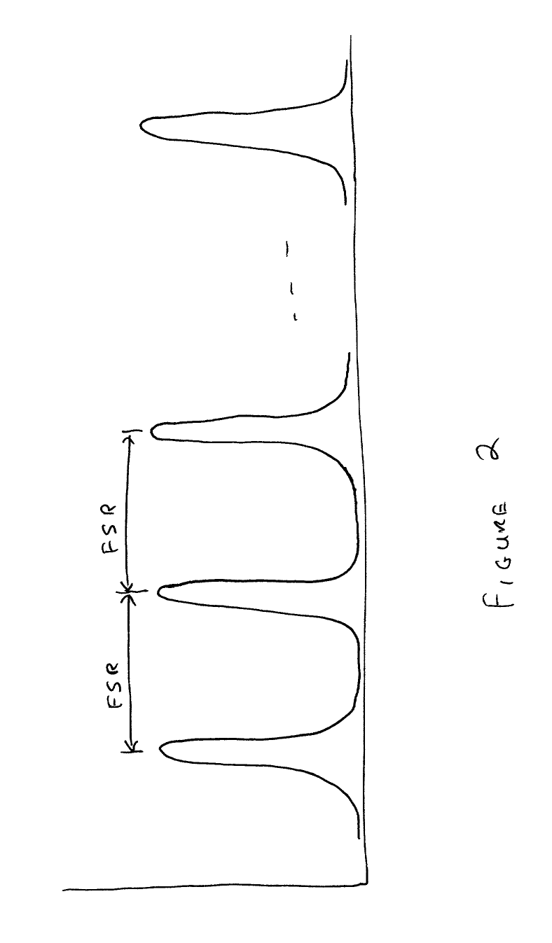

FIG. 1 illustrates a system 100 for generating laser radiation at multiple discrete wavelengths. The system 100 includes a source 101 of laser radiation, and a compound cavity 102. The compound cavity 102 includes an input reflective element 104 at one end, and an output reflective element 106 at the opposite end. The compound cavity 102 can support multiple discrete wavelengths or multiple modes of vibration. The wavelengths are separated by a constant frequency difference, which will be referred to as the Free Spectral Range (FSR). This constant frequency difference is also referred to as the frequency spacing. A spectral profile of the compound cavity 102 is shown in FIG. 2. The FSR of the compound cavity 102 may be determined from equation (1):

FSR=(FSR_{L}×FSR_{(L+DL)})/(FSR_{L}−FSR_{(L+DL)}) (1)

where

FSR_{L}=c/(2×n×L) (2)

and

FSR_{(L+DL)}=c/(2×n×(L+DL)) (3)

and where “c” is the speed of light, “n” is the refractive index of the cavity, “L” is a first characteristic length of the cavity 102, and L+DL is a second characteristic length of the cavity 102.

Thus the frequency separation of the modes of vibration that the compound cavity 102 can support is a function of the distance DL. For example, a refractive index n=1.5 and a distance DL of about 4 mm results in a FSR of 50 GHz. The FSR can be selected to correspond to the frequency separation of an industry standard, such as the ITU standard grid.

The laser radiation provided by the source 101 is coupled into the compound cavity 102. The wavelength of the radiation generated by the source 101 corresponds to one or more of the wavelengths that are desired in the spectral profile. The radiation provided by the source 101 may be continuous or pulsed. Pulsed radiation can be used to enhance peak power.

If the radiation source 101 provides pulsed radiation, the second characteristic length may be L+DL+mL1. Integer m is equal to or greater than zero, and distance L1 corresponds to the repetition rate of the source 101 of pulsed radiation. L1 is the distance between pulses being propagated in the cavity 102.

The pulsed radiation is generated at a pulse repetition rate that has a rational number relationship to the desired FSR. For example, if the FSR is 50 GHz, a pulse repetition rate of 2.5 GHz or an integer multiple thereof (e.g., 10 GHz) would be appropriately related.

The system 100 further includes a non-linear medium 108 within the compound cavity 102. The non-linear or an harmonic aspect of the medium 108 facilitates the absorption of the source or pump radiation at its wavelength and its re-radiation at a continuum of wavelengths. The cavity 102 enhances the propagation of only the wavelengths in the spectral profile. As the source 101 provides additional energy to the non-linear medium 108, that energy is transferred to the supported modes of vibration. Thus the cavity 102 and the non-linear medium 108 provide an energy-efficient means for transferring energy from the pump radiation to the desired supported wavelengths. The peak power of pulsed radiation also enhances the nonlinear effects of the non-linear medium 108.

Thus the non-linear medium 108 re-radiates at the different frequencies. The non-linear or anharmonic aspects of the non-linear medium 108 may be characterized by a coefficient. For a description of this coefficient, as well as a discussion of non-linear media, see Govind P. Agrawal, “Non Linear Fiber Optics,” 2nd ed., Academic Press, ISBN 0-12-045142-5, 1995.

The non-linear medium 108 may be a non-linear optic fiber. The optic fiber may be straight, wound in a loop, or given any other path. Diameter of the fiber is a design choice. Reducing the diameter spatially concentrates the laser energy and, therefore, increases peak power. Although the non-linear medium 108 may be a fiber, it is not so limited.

The output optical beam of the compound cavity 102 is supplied via a single optical fiber 110 to an integrated device 112, which separates the output beam into multiple beams having different wavelengths, modulates data onto the beams, and combines the beams back into a single beam. As an alternative to an integrated device 112, separate components may be used: an arrayed wave guide or free space grating for spatially separating the output beam into separate beams of different wavelengths; an array of reflective modulators for modulating data from electronic signals onto the separate beams; and a recombiner for combining the separate beams back into a single beam.

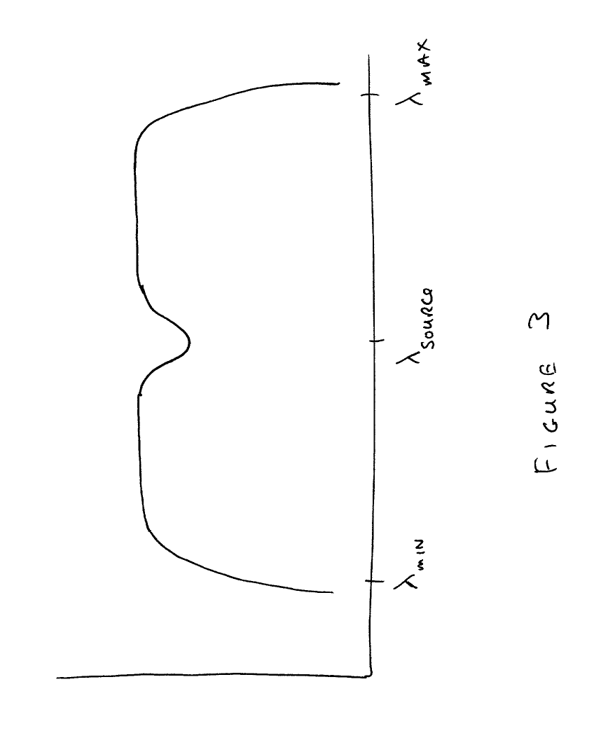

An exemplary reflectivity profile of the input reflective element 104 is illustrated in FIG. 3. The input reflective element 103 is designed to allow the pump radiation from the pulsed radiation source 101 to be coupled into the cavity 102 and is also designed to strongly reflect the generated wavelengths, thus confining them to the cavity 102. The reflectivity profile includes a high reflection value over the desired wavelength range (λ_{MIN} to λ_{MAX}), with the exception of a range (e.g., a notch) of lower reflection values at each pump wavelength (λ_{PUMP}) or wavelengths (since there can be more than one pump wavelength). The lower reflection values are selected to optimize coupling of pump radiation into the cavity 102.

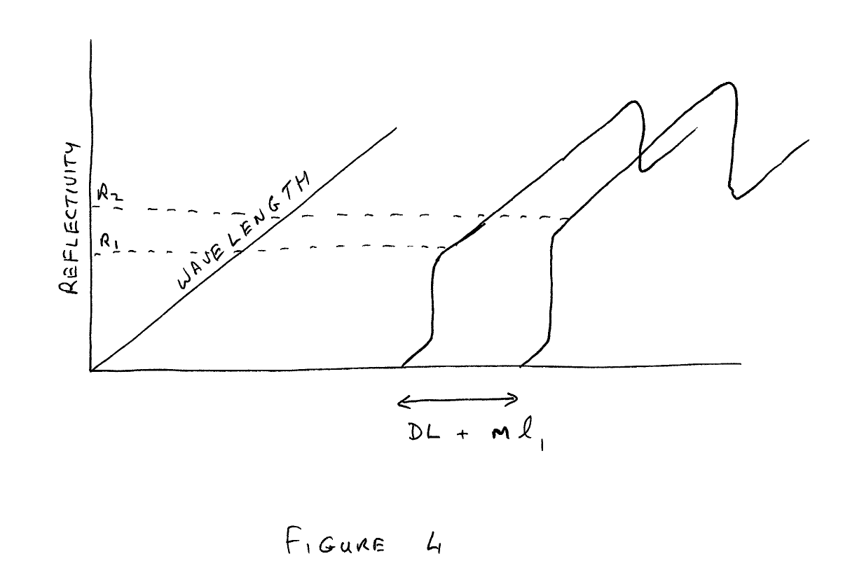

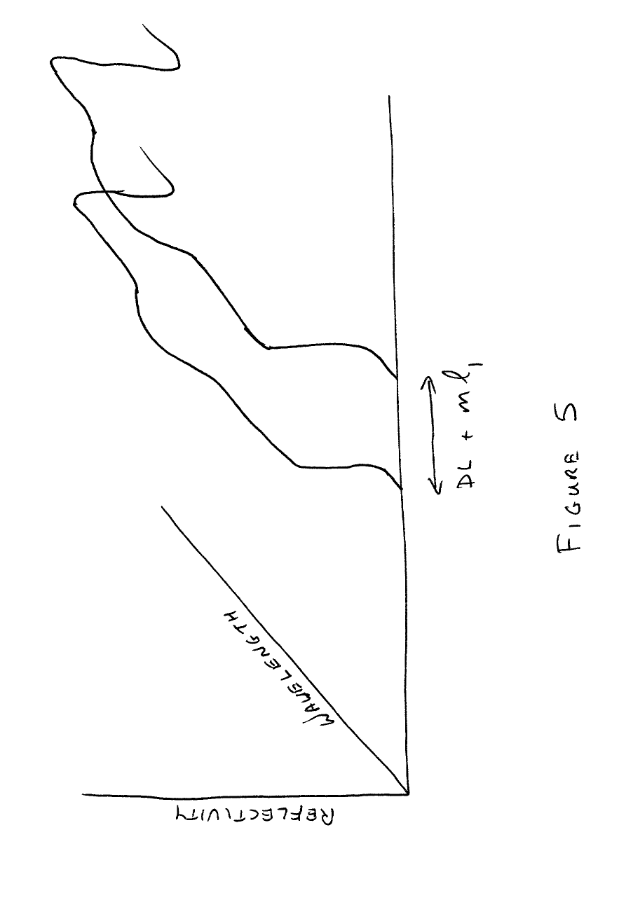

Exemplary reflectivity profiles of the output reflective element 106 are shown in FIGS. 4 and 5. The reflectivity profile of the output reflective element 106 may be equivalent to the profiles of two reflective elements separated by a distance DL (or mL1+DL). The first equivalent reflective element has a first reflectivity profile with a constant reflectivity R1 across all the desired wavelengths; and the second equivalent reflective element has a second reflectivity profile with a constant reflectivity R2 across all the desired wavelengths The output reflective element 106 can operate as an output coupler for the compound cavity 102, with the desired multiple wavelength radiation. The output reflective element has two reflectivity profiles designed to optimize the transfer of energy to the desired wavelengths and the suppression on radiation at the undesired wavelengths. These reflectivity profiles can also be designed to equalize the output radiation power at different wavelengths (the output power in the profile of FIG. 5 is equalized; the output power in the profile of FIG. 4 is not equalized).

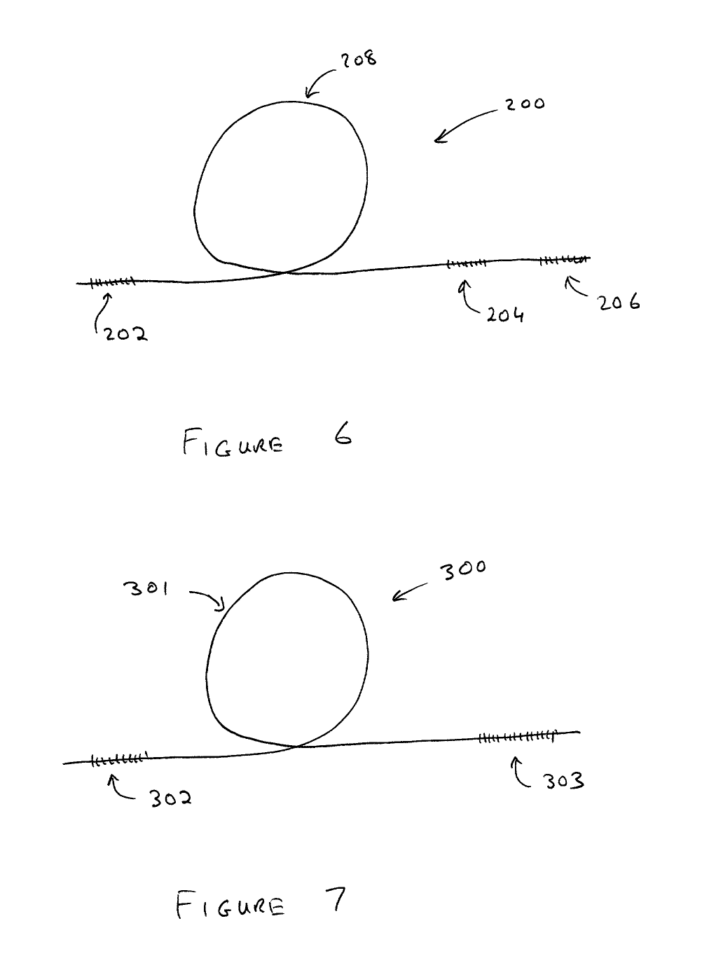

Reference is now made to FIG. 6, which shows a first embodiment of the compound cavity: a compound resonant cavity 200. The compound resonant cavity 200 includes a first (input) reflective element 202 at one end, and spaced-apart second and third reflective elements 204 and 206 at the other end. The characteristic length between the input reflective element 202 and the second reflective element 204 is a distance L, and the characteristic length between the second and third reflective elements 204 and 206 is the distance DL. If the radiation source provides pulsed radiation, the characteristic length between the second and third reflective elements 204 and 206 may be distance DL+mL1. The second and third reflective elements 204 and 206 have reflectivity profiles designed to optimize the transfer of energy to the desired wavelengths and the suppression on radiation at the undesired wavelengths (as shown in FIGS. 4 and 5). The non-linear medium 208 may be a non-linear optic fiber.

All three reflective elements 202-206 may be Bragg gratings that are formed in the non-linear fiber 208. Fiber Bragg gratings provide sequences of variations in the refractive index of the fiber and can be designed to reflect radiation with specific wavelength dependent reflectivity profiles. Instead, the second element 204 may be a Bragg grating, but the third reflective element 206 may be a mirrored coating at the end of the nonlinear medium 208.

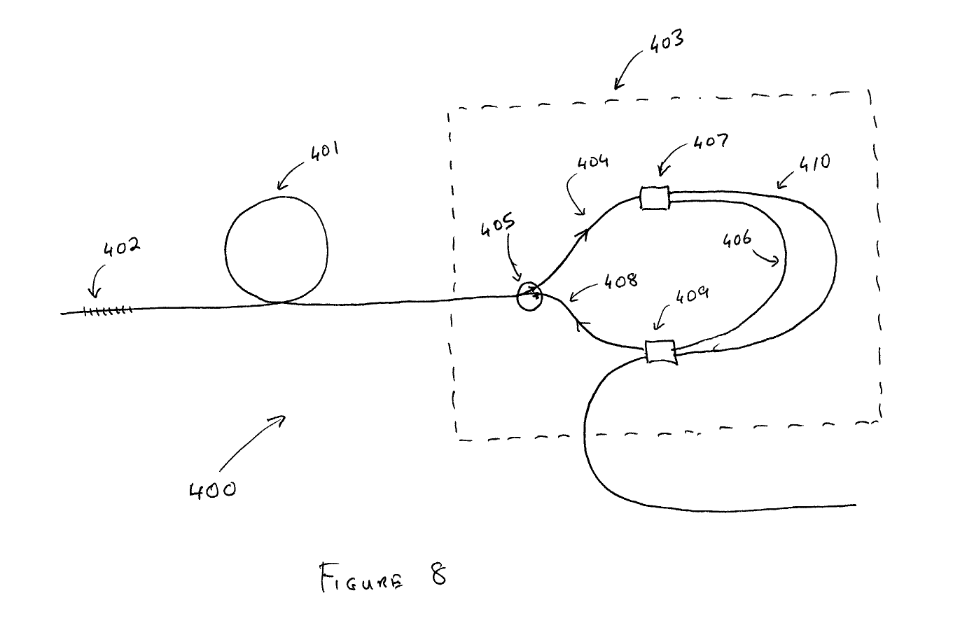

Reference is now made to FIG. 7, which shows a second embodiment of the compound cavity. The cavity 300 of FIG. 7 contains a non-linear fiber 301, and includes an input Bragg grating 302 imprinted on one end of the fiber 301, and a compound Bragg grating 303 imprinted on a second end of the fiber 301. The input Bragg grating 302 serves as an input reflective element.

A typical reflectivity profile of the compound grating 303 is illustrated in FIG. 4. The compound grating design can be generated, for example, by the superposition of two spatially overlapping gratings

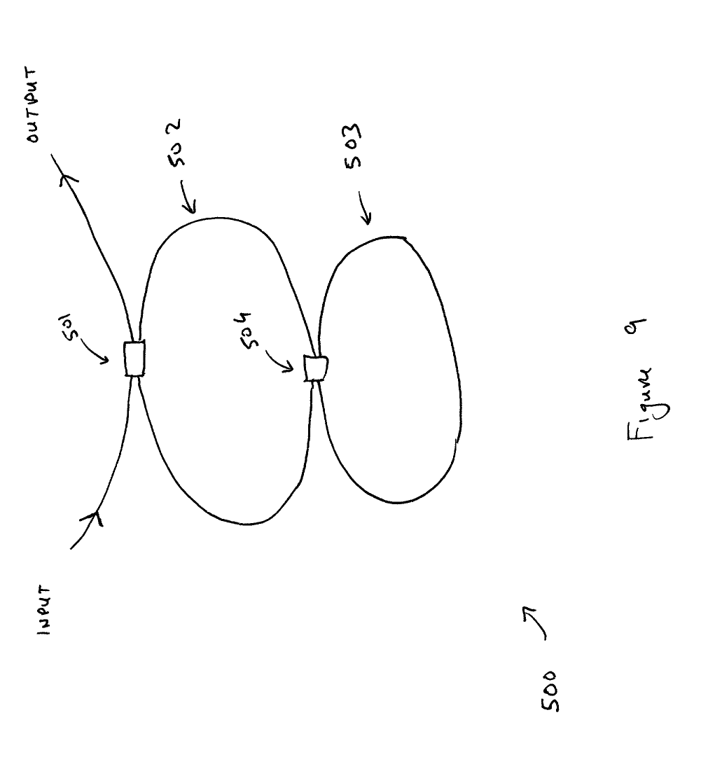

FIG. 8 shows a third embodiment of the compound cavity. The cavity 400 of FIG. 8 contains a non-linear fiber 401, and includes an input reflective element 402 such as a Bragg grating imprinted on one end of the fiber 401. A compound reflective element 403 includes a double fiber loop. The first fiber loop includes the output 404 of a circulator 405, the output 406 of a splitter 407 and the output 408 of a coupler 409. The coupler output 408 is then supplied to the circulator 405 to complete the first fiber loop. The second fiber loop also includes the output 404 of the circulator 405 and the second output 410 of the splitter 407 and also the coupler output 408. The length difference between the two outputs 406 and 410 of the splitter 407 determines the FSR of the cavity 400. The detailed characteristics of the spectral profile can be controlled by the relative strengths of the two outputs of the splitter 407 and the relative strengths of the inputs to the coupler 409. An output of the coupler 409 provides an output from the cavity 400.

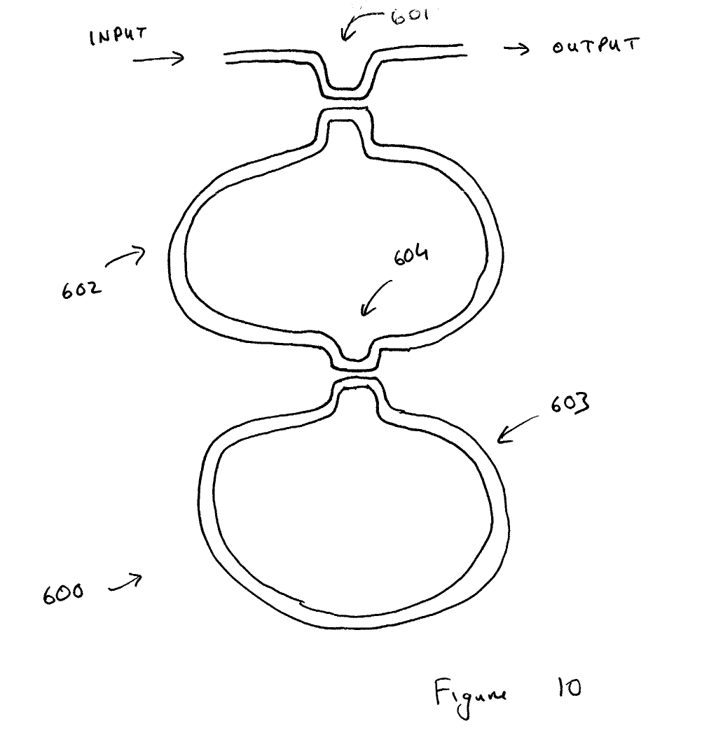

FIG. 9 shows a fourth embodiment of the compound cavity. The cavity 500 of FIG. 9 includes an input coupling element 501, first and second non-linear elements 502 and 503 in ring configurations, and a coupling element 504 for coupling the first non-linear element 502 to the second non-linear element 503. The length difference between the non-linear elements 502 and 503 determines the FSR of the compound cavity 500. This fourth embodiment is implemented using optical fibers.

FIG. 10 shows a fifth embodiment of the compound cavity. The cavity 600 of FIG. 10 is the same as the cavity 500 of FIG. 9, except that waveguides 602 and 603 are used instead of fibers. Elements 601 and 604 are couplers.

Thus disclosed are systems that can generate an optical beam having multiple wavelengths, yet that have a reduced number of laser diodes, fibers, and optical connections. Reducing the number of laser diodes, fibers and optical connections reduces system cost and size, and increases robustness and reliability.

The systems are not limited to fibers for guiding optical waves. Other technologies for guiding optical waves may be used.

The present invention is not limited to the specific embodiments described and illustrated above. Instead, the present invention is construed according to the claims that follow.

1. Apparatus for generating laser radiation having a plurality of discrete wavelengths, the apparatus comprising:
a compound cavity; and
a non-linear element within the cavity.

2. The apparatus of claim 1, wherein the cavity is a compound resonant cavity.

3. The apparatus of claim 2, wherein spacing between wavelengths of radiation within the cavity is a function of the speed of light, the refractive index of the cavity and characteristic length difference of the compound cavity.

4. The apparatus of claim 1, wherein the cavity includes an input element, a reflectivity profile of the input element having a high reflection value over a desired wavelength range, except for a range of lower reflection values at each pump wavelength.

5. The apparatus of claim 1, wherein the cavity includes two spaced-apart reflective elements proximate an end of the cavity.

6. The apparatus of claim 1, wherein the cavity includes a compound diffractive grating proximate an end of the cavity.

7. The apparatus of claim 1, wherein the cavity includes a reflective coating on an end of the non-linear element, and a diffractive grating proximate to the coated end of the non-linear element.

8. The apparatus of claim 1, wherein the cavity includes a multiple path structure proximate an end of the non-linear element, the multiple path structure including first and second optical fibers of different characteristic length.

9. The apparatus of claim 8, wherein the structure further includes a separator proximate to inputs of the fibers, and a circulator proximate to outputs of the fibers.

10. The apparatus of claim 1, wherein the non-linear element includes a non-linear waveguide.

11. The apparatus of claim 1, wherein the non-linear element includes a non-linear fiber.

12 The apparatus of claim 1, wherein the cavity resonates at frequencies that correspond to a standard grid.

13. The apparatus of claim 1, further comprising a source of radiation having a stable frequency; the source having an output optically coupled to an input of the cavity.

14. The apparatus of claim 1, wherein the compound cavity is designed to support multiple wavelengths separated by the Free Spectral Range of the cavity.

15. An optical communications system comprising:
a laser;
a compound resonant cavity having an input coupled to an output of the laser, the compound resonant cavity designed to support multiple modes of vibration; and
a non-linear medium within the cavity, the non-linear medium positioned to receive laser radiation from the laser and re-radiate at a continuum of wavelengths.

16. The system of claim 15, wherein spacing between wavelengths of radiation within the cavity is a function of the speed of light, the refractive index of the cavity and characteristic length difference of the compound cavity.

17. The system of claim 15, wherein the cavity includes an input element, a reflectivity profile of the input element having a high reflection value over a desired wavelength range, except for a range of lower reflection values at each pump wavelength.

18. The system of claim 15, wherein the cavity includes two spaced-apart reflective elements proximate to an end of the non-linear medium.

19. The system of claim 15, wherein the cavity includes a compound diffractive grating proximate to an end of the non-linear medium.

20. The system of claim 15, wherein the cavity includes a reflective coating on an end of the non-linear medium, and a diffractive grating proximate to the coating.

21. The system of claim 15, wherein the cavity includes a multiple path structure proximate to an end of the non-linear element, the multiple path structure including first and second optical fibers of different characteristic length.

22. The system of claim 21, wherein the structure further includes a separator proximate to inputs of the fibers, and a circulator proximate to outputs of the fibers.

23. The system of claim 15, wherein the non-linear element includes a non-linear waveguide.

24. The system of claim 15, wherein the non-linear element includes a non-linear fiber.

25. The system of claim 15, wherein the cavity resonates at frequencies that correspond to a standard grid.

26. An optical communications system comprising:
means for generating radiation having a stable wavelength;
means for non-linearly spreading the spectrum of the radiation; and
means for reflecting the spread-spectrum radiation to support a plurality of evenly-spaced modes of vibration.

27. Apparatus for processing laser radiation having a stable frequency, the apparatus comprising:
means for non-linearly spreading a spectrum of the radiation; and
means for supporting a plurality of modes of vibration of the spread-spectrum radiation.

28. Apparatus for a generating laser radiation having a plurality of discrete wavelengths from laser radiation having a stable wavelength, the apparatus comprising:
an anharmonic element; and
input and output optical elements optically coupled to the anharmonic element, the input and output optical elements defining a compound cavity.

29. The apparatus of claim 28, wherein spacing between wavelengths of radiation within the cavity is a function of the speed of light, the refractive index of the cavity and characteristic length difference of the compound cavity.

30. The apparatus of claim 28, wherein the input element has a high reflection value over a desired wavelength range, except for a range of lower reflection values at each pump wavelength.

31. The apparatus of claim 28, wherein the output optical element includes two spaced-apart reflective elements.

32. The apparatus of claim 28, wherein the output optical element includes a compound diffractive grating.

33. The apparatus of claim 28, wherein the output element includes a reflective coating on an end of the anharmonic element, and a diffractive grating proximate to the coating.

34. The apparatus of claim 28, wherein the output optical element includes a double fiber loop.

35. The apparatus of claim 34, further comprising a separator proximate to inputs of fibers of the loop, and a circulator proximate to outputs of the fibers.

36. The apparatus of claim 28, wherein the non-linear element includes a non-linear waveguide.

37. The apparatus of claim 28, wherein the non-linear element includes a non-linear fiber.

38. The apparatus of claim 28, wherein the cavity is designed to resonate at frequencies that correspond to a standard grid.

39. A method of generating pulsed radiation having a plurality of discrete wavelengths, the method comprising:
generating radiation having a stable wavelength;
non-linearly spreading the spectrum of the radiation; and
reflecting the spread-spectrum radiation in a cavity that supports a plurality of evenly-spaced modes of vibration.
